(19) United States
(12) Patent Application Publication
(10) Pub. No.: US 2009/0014544 A1
(43) Pub. Date: Jan. 15, 2009

(54) RETAIL CASH DRAWER WITH INTEGRATED CHANGE HELPER DISPLAYS

(75) Inventors: Aaron R. Cox, Tucson, AZ (US); Thomas J. Sluchak, Apex, NC (US); Ronald A. Smith, Wake Forest, NC (US); Robert P. Tennant, Raleigh, NC (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/774,668

(22) Filed: Jul. 9, 2007

(51) Int. Cl. G07G 1/06

(52) U.S. Cl. 235/7 A

(57) ABSTRACT

A cash register having a cash drawer, the cash drawer including currency compartments, each of the currency compartments having a display for indicating a quantity of currency to be withdrawn from the respective currency compartment.

IBM® is a registered trademark of International Business Machines Corporation, Armonk, New York, U.S.A. Other names used herein may be registered trademarks, trademarks or product names of International Business Machines Corporation or other companies.

### BACKGROUND OF THE INVENTION

1. Field of the Invention

This invention relates to the field of retail cash registers and point of sale.

2. Description of the Related Art

Cash registers are generally used to record sales transactions and hold currency. Typically, a cashier who works for a company selling a product operates the cash register. During a sales transaction, the cashier enters the items sold either manually by pressing keys or automatically with an optical or non-optical scanner. When all the sales items for a customer are recorded, the cash register will add the sales item prices, calculate any sales tax if applicable, and display a total amount due. After the total amount due is displayed, the cashier can accept payment from the customer. If the customer is paying with cash, the cashier will accept the cash and key enter into the cash register the amount tendered by the customer. The cash register will display an amount of change due to the customer and a cash drawer will usually open. The cashier will complete the transaction by providing the amount of change to the customer. Cash transactions are usually performed using the cash drawer.

The cash drawer is typically part of the cash register although the cash drawer may sometimes be located separately from a section of the cash register having a display and input devices. The cash drawer generally has separate currency compartments for each denomination of currency. For example, in the United States, for paper currency, there are currency compartments for one-dollar bills, five-dollar bills, and so on. Similarly for coins, there are currency compartments for pennies, nickels, dimes and etc. For other countries and regions of the world, cash drawers have similar bill and coin compartments to accommodate the country or region-specific currency.

The cashiers are responsible for sorting and placing cash received from the customer into appropriate currency compartments. Also, the cashiers are responsible for making change by removing currency from the appropriate currency compartments. The cashier typically may use his or her discretion for determining which denominations to use for making the change.

Retail cashiers can be in limited supply in certain cities and geographies. Consequently, retailers may hire some individuals with limited mathematics skills to work as cashiers. For cashiers with limited math skills making change can be a challenge. Some of the cashiers may not be able to count well.

If the cashier cannot count well, mistakes can be made in removing currency from the cash drawer to male change. If too much change is mistakenly dispensed, the retailer will lose money. If too little change is dispensed, a customer will be shortchanged and may choose not to shop with this retailer in the future. Other problems may result from the cashier using his or her discretion when making change. For example, if the cashier does not select coins and bills in a fashion that uses the least number from each currency compartment, time is wasted making change. A delay will unnecessarily add to transaction time, possibly upsetting the customer being served and those waiting in a queue.

In retrieving currency of a given denomination from the associated currency compartment, cashiers are required to mentally total the cumulative value of the currency pulled from each currency compartment as well as the overall total pulled from all the currency compartments collectively. An improvement, suggested in prior art, is to have the cash register recommend the number of currency units, bills or coins, to be pulled from each currency compartment. The cashier then can pull the recommended number of currency units from each currency compartment without being required to mentally total the value of the currency pulled from the currency compartments individually or collectively.

To help cashiers select appropriate currency in an efficient manner, prior art described algorithms or calculation methods for determining the least number of bill or coin pulls to total a given amount. However, previously proposed ideas typically used remote displays or remote indicators to tell the cashier what coin or bill quantity to withdraw from the cash drawer. One drawback to using remote displays is that the cashier may loose concentration or be distracted in the time interval between reading the remote display and looking at the cash drawer.

Therefore, what are needed are an apparatus and method for the cashier to accurately and quickly make change.

### SUMMARY OF THE INVENTION

The shortcomings of the prior art are overcome and additional advantages are provided through the provision of a cash register having a cash drawer, the cash drawer including currency compartments, each of the currency compartments having a display for indicating a quantity of currency to be withdrawn from the respective currency compartment.

Also disclosed is a method for producing a cash register having a cash drawer, the method including selecting a display for each currency compartment of the cash drawer; placing each display in proximity to each respective currency compartment; and coupling each display to an output of the cash register; wherein an output signal provides a user with an indication of a quantity of currency to withdraw from each respective compartment for completion of a cash transaction.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for a cashier to accurately and quickly make change through the provision of a cash register having a cash drawer, the cash drawer including currency compartments, each of the currency compartments having a display for indicating a quantity of currency to be withdrawn from the respective currency compartment.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment of a cash register;

FIG. 2 illustrates an exemplary embodiment of a cash drawer with a display for each currency compartment;

FIG. 3 illustrates an exemplary embodiment of the cash drawer with the display indicating the most efficient denomination removal for $90.85 in change; and

FIG. 4 presents an exemplary method for producing a cash register with the cash drawer with the display for each currency compartment.

The detailed description explains the preferred embodiments of the invention, together with advantages and features, by way of example with reference to the drawings.

### DETAILED DESCRIPTION OF THE INVENTION

The teachings provide a cash drawer that displays a quantity of each denomination of currency to be given to a customer as change. Typically, the cash drawer is part of a cash register. The cash drawer has separate compartments referred to as “currency compartments.” Each currency compartment contains one denomination of currency. A display is arranged with each currency compartment. Each display indicates a number of bills or coins in the currency compartment to be provided to the customer as change. The amounts of each denomination are calculated to provide a least number of withdrawals or pulls of currency from the cash drawer.

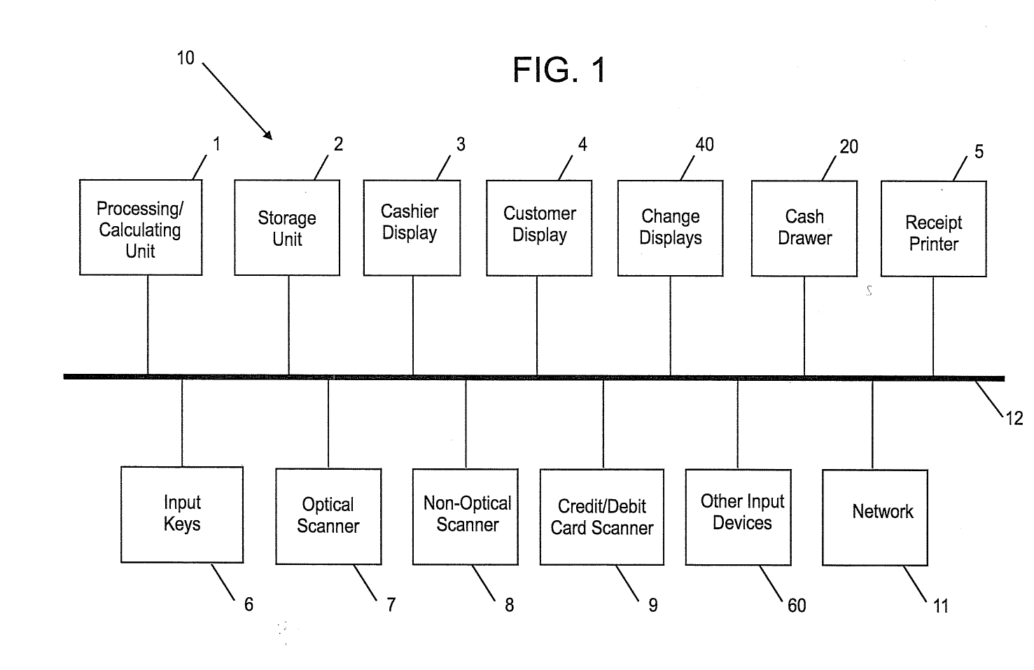

Referring now to FIG. 1, an exemplary embodiment of a cash register 10 for implementing the teachings herein is depicted. The cash register 10 includes a processing/calculating unit 1. The calculating unit 1 calculates the least number of withdrawals or pulls of currency from the cash drawer. The calculating unit 1 is coupled to storage 2 and various other components via a bus 12. The cash register 10 includes a cash drawer 20 connected to the bus 12. The bus 12 also provides for communicating with a network 11. Not depicted but provided are any interface units or adapters required to couple any components or networks to the bus 12.

FIG. 1 further depicts a cashier display 3 and a customer display 4. Also shown connected to the bus 12 are change displays 40 used to indicate the number of bills or coins in each currency compartment to be provided to the customer as change. A receipt printer 5 provides for printing a receipt for a customer making a purchase. The cash register 10 includes input devices such as input keys 6, optical scanner 7, non-optical scanner 8, credit/debit card scanner 9, and other input devices 60.

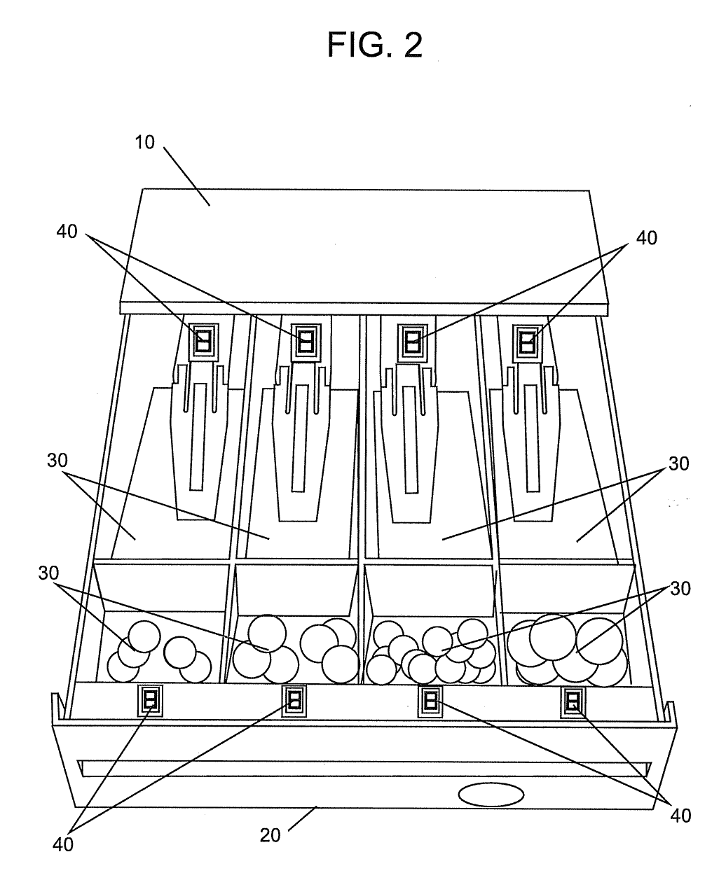

FIG. 2 illustrates an exemplary embodiment of the cash drawer 20 using the displays 40. Referring to FIG. 2, the cash register 10 includes the cash drawer 20. FIG. 2 illustrates the cash drawer 20 in an open position. The cash drawer 20 includes a currency compartment 30 for each denomination of currency. For teaching purposes, the embodiment of FIG. 2 includes eight currency compartments 30. The teachings provide for a cash drawer 20 with any number of currency compartments 30. Each currency compartment 30 includes the display 40. One display 40 is associated proximally and uniquely with each currency compartment 30. The display 40 is located to minimize interference withdrawal of currency and to maximize legibility. The display 40 illustrated in FIG. 2 is a single digit display. The teachings provide for the display 40 to be one or more digits. One exemplary embodiment of the display 40 is a numeric display with light-emitting diodes (LEDs). Other exemplary embodiments of the display 40 include liquid crystal display (LCD), organic light-emitting diodes (OLED), plasma, and electronic ink. The display 40 is typically designed and constructed to receive output from the calculating unit 1.

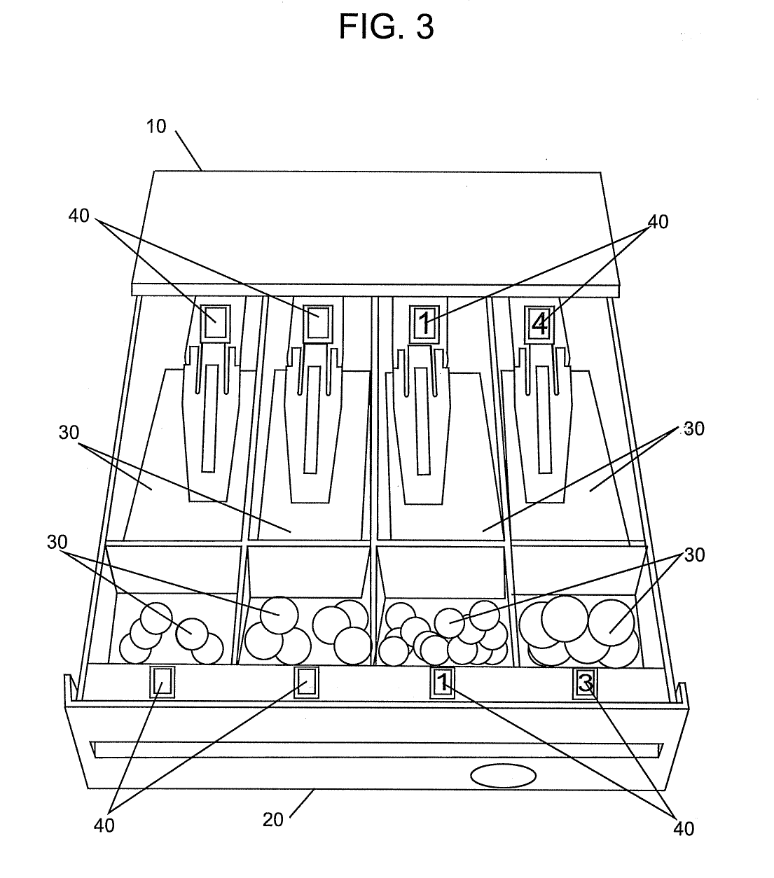

An example of operation of the teachings is now provided. Consider a customer making a purchase that totals $8.15. The customer tenders to a cashier a one hundred-dollar bill. The cashier enters $100.00 into the cash register 10 as an amount tendered by the customer. The cash register 10 determines change due to the customer and displays $90.85 as the change due. The cash register 10 also determines the quantity of each denomination of currency to be provided for the least number of currency withdrawals. The cash drawer 20 opens and the display 40 associated with each currency compartment 30 indicates the quantity of currency to be withdrawn. For this example, the cash register 10 determines that the least number of currency unit withdrawals is four twenty-dollar bills, one ten-dollar bill, three quarters, and one dime. FIG. 3 illustrates an exemplary embodiment of the cash drawer 20 with the displays 40 indicating the change due the customer in this example. Referring to FIG. 3, the display 40 associated with the currency compartment 30 for twenty-dollar bills indicates a “4,” the display 40 associated with the currency compartment 30 for ten-dollar bills indicates a “1” and so on. In accordance with the teachings herein, the cashier can make change by withdrawing currency in the quantity of each denomination as indicated by the displays 40.

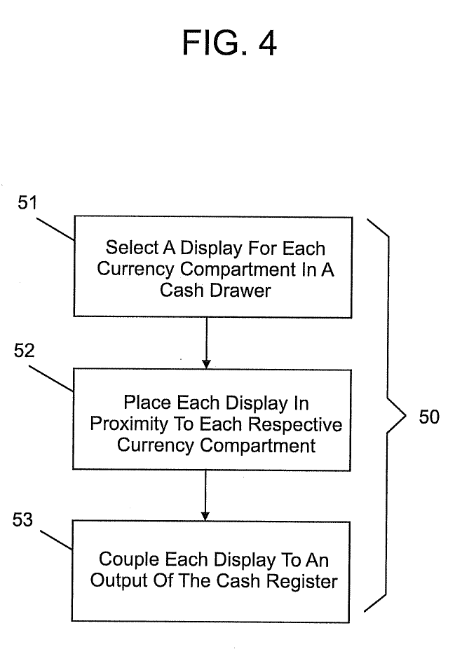

An exemplary method 50 is presented in FIG. 4 for producing the cash register 10 with the displays 40. A first step 51 calls for selecting the display 40 for each currency compartment 30 of the cash drawer 20. A second step 52 calls for placing each display 40 in proximity to each respective currency compartment 30. A third step 53 calls for coupling each display 40 to an output of the cash register 10. The output typically provides a cashier with an indication of a quantity of currency to withdraw from each respective currency compartment 30 for completion of a cash transaction.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A cash register comprising a cash drawer, the cash drawer comprising currency compartments, each of the currency compartments comprising:
a display for indicating a quantity of currency to be withdrawn from the respective currency compartment.

2. The register as in claim 1, wherein the display comprises light-emitting diodes.

3. The register as in claim 1, wherein the display comprises organic light-emitting diodes.

4. The register as in claim 1, wherein the display comprises a liquid crystal display.

5. The register as in claim 1, wherein the display comprises an electronic ink display.

6. The register as in claim 1, wherein the quantity comprises a least amount to provide change.

7. A method for producing a cash register comprising a cash drawer, the method comprising:
selecting a display for each currency compartment of the cash drawer;
placing each display in proximity to each respective currency compartment; and
coupling each display to an output of the cash register,
wherein an output signal provides a user with an indication of a quantity of currency to withdraw from each respective compartment for completion of a cash transaction.
